(19) United States
(12) Patent Application Publication
(10) Pub. No.: US 2003/0052225 A1
(43) Pub. Date: Mar. 20, 2003

(54) Airplane pilot cockpit interlock safety entrance

(76) Inventor: Richard Walter Butzlaff, El Paso, TX (US)

Correspondence Address: Richard Butzlaff, 6582 Eagle Ridge Dr., El Paso, TX, 79912, US

(21) Appl. No.: 09/954,868

(22) Filed: Sep. 17, 2001

(51) Int. Cl. B64D 11/00; B64D 13/00

(52) U.S. Cl. 244/118.5

(57) ABSTRACT

An improved airplane cockpit entry to secure the cockpit area. By use of an interlock method using two doors that are controlled, lockable and unlockable, containing a small recognition area between the two doors. Control can be established to only allow authorized personnel to enter or exit securely and eliminate forcible, rushed entry, yet allowing ease of exiting the cockpit area for emergency conditions.

### CROSS-REFERENCE TO RELATED APPLICATIONS

Not Applicable

### STATEMENT REGARDING FEDERALLY SPONSORED RESEARCH AND DEVELOPMENT

Not Applicable

### REFERENCE TO MICROFICHE APPENDIX

Not Applicable

### BACKGROUND OF INVENTION

This invention relates to aircraft to improve safety and securement of the pilot cockpit area, specifically to improving the entrance to the pilot cockpit area. This double door feature will allow secure, easy departure from the pilot cockpit area and will restrict unwanted entrance to the pilot cockpit area.

### BACKGROUND-DESCRIPTION OF PRIOR ART

Aircraft doors to the cockpit area are a single door. If locked for securement the pilot has no means to securely leave the cockpit area. By opening the single locked door, person or persons could forcibly enter. By opening the locked door for someone trying to enter the pilot cockpit area for an emergency situation, again upon unlocking the single door person or persons could forcibly enter. The single door system also does not allow the pilot to know that someone could be tampering with or attempting to unlock the single door until completion and person or persons could forcibly enter.

### BRIEF SUMMARY OF THE INVENTION

Accordingly, the double door system will allow safe and secure leaving or entry of the cockpit area, preventing a forcible entry. The double door system will alert the pilot cockpit area to someone attempting to tamper with or unlock the entrance to the pilot cockpit area. He would be tampering with door 1, and even if unlocked would only be confronted by door 2 and the pilot notified. This advance notice could allow for safety precautions, evasive actions or possible retaliation, but not forcible, surprise entrance.

The double door system provides for a recognition area. This is a small area between door 1 and door 2, securely sealed off. An authorized person could enter door 1 to the recognition area then locking door 1 behind him, alert the personnel in the pilot cockpit area for recognition. After recognition that door 1 is locked and he is the only person in the recognition area, the pilot area could unlock door 2 allowing entrance to the pilot cockpit area for the authorized person. The recognition area in the double door system could also be used in leaving the pilot cockpit area as to leave no one forcibly get in and tamper with door 2. The double door system in an emergency situation could be unlocked and brisk exit could be performed through both doors.

Further objects and advantages of my invention will become apparent from a consideration of the drawings and ensuing description.

### BRIEF DESCRIPTION OF FIG. 1. VIEW OF THE DRAWING

FIG. 1 is a not to scale silhouette of the front portion of a fuselage to an airplane, depicting the area between the cockpit area and the passenger compartment. This is a floorplan view showing an additional compartment to form an interlock area for safe access and departure from the cockpit area, using recognition devices and controlled locking devices.

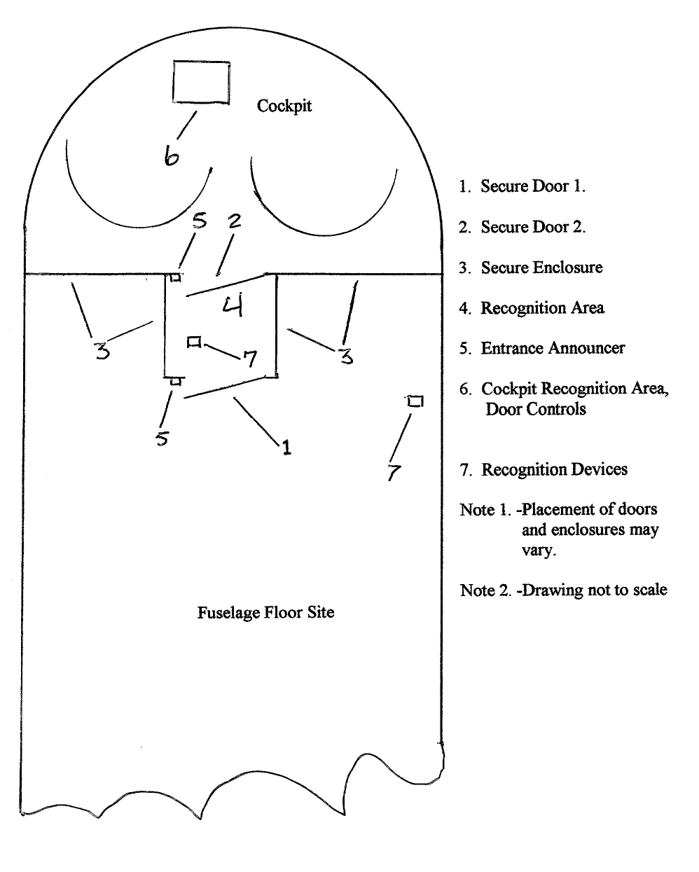

### DETAILED DESCRIPTION OF THE INVENTION

This invention is an interlock security system to prevent unauthorized personnel from entering the cockpit area. An authorized person wanting to enter the cockpit area from the passenger compartment area would announce his intent at door 1 using the Entrance Announcer. The personnel inside the cockpit area would check his outer recognition device to insure there is only one authorized person requesting entrance at which time the cockpit personnel will unlock door 1. The authorized person would then enter the final small recognition area, the area between door 1 and door 2. The authorized person would then be locked in by cockpit personnel locking door 1. The authorized person would then again request entrance by using the Entrance Announcer located in the final small recognition area. The cockpit personnel would then check the final small recognition area with its inner recognition device to confirm the authorized person is the only person entering. The cockpit personnel then unlocks door 2 and the authorized person enters the cockpit. The small recognition area between door 1 and door 2 and the aid of the locked door 1 would secure a rush from any intruders. Even if intruders rushed with the authorized person through door 1 and into the small recognition area by having the second check in the small locked area the cockpit personnel could avoid unauthorized entrance by not unlocking secure door 2. Again, allowing time to take counter measures and retaliation, not a surprised, forced entry. Also by adding the second door the door adjacent to the passenger compartment, if unauthorized persons tried to tamper with it's recognition device or tamper with the door for entry, the personnel in the cockpit would now have time to take preventative measures or retaliate but not be surprised or forcibly entered upon. Exiting of the cockpit area by cockpit personnel would be done in the reverse. Cockpit personnel checking the final recognition area, opening door 2, the authorized person exiting into the small recognition area, cockpit personnel, verifying this, locking door 2, then unlocking door 1. After the authorized person exits the small recognition area door 1 would be locked. This interlock system would not prevent evacuation of the cockpit area for by unlocking the two doors there would be a hallway and a useful emergency exit. The existing single door entry, exit to the cockpit area, upon opening or unlocking, even with a recognition device, could be stormed by intruders. Also, the single door does not allow for a small recognition area to insure only the authorized personnel are going to be entering.

What I claim as my invention is:

1. an interlock airplane cockpit entrance.
